(19) United States
(12) Patent Application Publication
(10) Pub. No.: US 2004/0267735 A1
(43) Pub. Date: Dec. 30, 2004

(54) Method of equalizing opportunity for exposure in search results and system for same

(76) Inventor: Michael Anthony Melham, Belleville, NJ (US)

Correspondence Address: Michael A. Melham, 196 Joralemon St., Belleville, NJ, 07109, US

(21) Appl. No.: 10/849,993

(22) Filed: May 20, 2004

Related U.S. Application Data
(60) Provisional application No. 60/472,236, filed on May 21, 2003.

(51) Int. Cl. G06F 7/00

(52) U.S. Cl. 707/3

(57) ABSTRACT

Information is displayed at a terminal. Search criteria is received. A database is searched for the search criteria to determine search results. The search results are displayed in random order.

### PRIORITY AND RELATED APPLICATION

This application claims priority to U.S. Provisional Application Serial No. 60/472,236, filed May 21, 2003, titled “Random Listing of Search Results” which is herein incorporated by reference in its entirety.

### FIELD OF THE INVENTION

This invention relates generally to displaying database information in random form and more particularly to displaying search results on the Internet and/or Intranet and/or a software program in a random rather than alphabetical order.

### BACKGROUND INFORMATION

Internet advertising has become more mainstream. Businesses are devoting more time and financial resources to this relatively new advertising medium. One reason is because of cost. Return on investment (ROI) is closely monitored by advertisers; the Internet typically affords much lower cost than traditional media and can have the potential for higher rate of return. One phrase associated with Internet advertising is cost per impression (CPI). Advertisers pay a higher fee just to have their advertisement (name, banner, or link) appear. In this manner, the advertiser pays just to have the user see their advertisement, and pays regardless of whether or not a user actually clicks on the their advertisement. Another phrase associated with Internet advertising is cost per click through. In this method of advertising, the advertiser is only charged when a user clicks on the link associated with that advertiser.

Conventional advertising media, such as telephone directories, show the listings in alphabetical order. As a result, businesses with names starting with numerals or the letter “A” always show up first in the listings. Because the consumer is constrained to viewing the information on a printed page, no other logical way exists to express the information, besides using alphabetical order. Thus, as a consumer searches the telephone directory under a given listing, he first sees the advertisers starting with numerals followed by advertisers starting with letter “A.” Consequently, consumers are more likely to make calls to advertisers whose names start with letters that are earlier in the alphabet. Businesses realize this, and many change their names, or start business under a name, with a prefix such as “Al” (e.g. “Al Auto Supply”) or even by placing a symbol in front of their name. Using a prefix such as this allows the business to appear first or at the beginning of the advertising for that category in the directory. Businesses with names starting with numerals or letters that occur later in the alphabet get less exposure than the businesses with names starting with numerals or letters that appear earlier.

When the search results are displayed alphabetically, a company such as “Al Auto Supply” has no incentive to pay for a search listing, because it will always appear near the top. This may deprive the company providing the search results of opportunities to make greater revenue because advertisers such as “Al Auto Supply” would never have an incentive to pay.

Some internet yellow page directories, such as yp.yahoo.com, have attempted to solve this problem by creating a “sponsored” and a “basic” listing. By paying a fee to the internet yellow page directories, a business may get greater exposure than it would by remaining in the basic listing because the sponsored list appears before the basic list. Thus, a business with a name starting with a letter that occurs later in the alphabet may get greater exposure on the sponsored list than merely by remaining at the bottom of the basic list. This is because there are less businesses on the sponsored list than on the basic list, and so even a business with a name starting with a letter that occurs later in the alphabet may get more exposure on the sponsored list, even though the sponsored list still shows the results in alphabetical order. The businesses that do not pay, or that pay a lesser amount, may be left in the basic listing in alphabetical order. FIGS. 1(a) and 1(b) depict the Yahoo!® Get Local Yellow Pages search results for “Florists” in Caldwell, N.J. and demonstrate this principle.

A need exists to provide more equal exposure to all businesses regardless of their name.

### SUMMARY OF THE INVENTION

The present invention addresses the drawbacks of the prior art by displaying the search results in random order, rather than merely alphabetically. Thus, subscribers with names starting with letters that occur later in the alphabet have the same probability of being at the top of the list as subscribers with names starting with letters that appear earlier in the alphabet. Note that displaying search results in “random order” is not the same as displaying search results in “no order.” If search results are displayed in “no order,” the same search criteria will yield search results appearing in the same “no order” fashion over and over again. However, when search results are displayed in “random order,” the same search criteria may yield search results appearing in different orders each time the same search criteria is input or selected.

In accordance with one aspect of the present invention, information is displayed by the following steps: receiving search criteria; searching a database for the search criteria or a representation of the search criteria to determine search results; and displaying the search results in a random order.

In another aspect of the present invention, two lists are used. Subscribers that pay a premium (or for whatever reason are chosen by an administrator to be in the first list) are displayed on the first list, which appears before the second list. Both lists display the results in random order. The first list, however, has several advantages over the second list. The first list can contain much of the same information as the second list (i.e., they both may contain data pertinent to a business, such as the business name, address, and phone number); however, additional optional information may be displayed on the first list. This can include advertising slogans, or the use of color and graphics such as a company logo.

### BRIEF DESCRIPTION OF THE DRAWINGS

Further objects, features and advantages of the invention will become apparent from the following detailed description taken in conjunction with the accompanying figures showing a preferred embodiment of the invention, on which:

FIGS. 1(a) and 1(b) show a webpage displaying search results in a conventional alphabetical manner.

FIG. 2 is a diagram of the interacting components of a system for displaying information according to an exemplary embodiment of the present invention;

FIG. 3 is a flow diagram illustrating an exemplary process whereby information is displayed;

FIG. 4 is a flow diagram illustrating an exemplary process for organizing and displaying information in a random order;

FIG. 5 is a webpage showing search criteria that a user may select according to an exemplary embodiment of the present invention;

FIGS. 6-11 depict an alphabetical listing of subscribers stored in a database;

FIG. 12 depicts search results randomly displayed at the terminal based on search criteria used to search the listing of subscribers in FIGS. 6-11;

FIG. 13 depicts search results based on the same search criteria used in FIG. 12;

FIG. 14 is a diagram illustrating an exemplary computer system for performing the procedures illustrated in FIGS. 2-13; and

FIG. 15 is a block diagram illustrating an exemplary processing section for use in the computer system illustrated in FIG. 14.

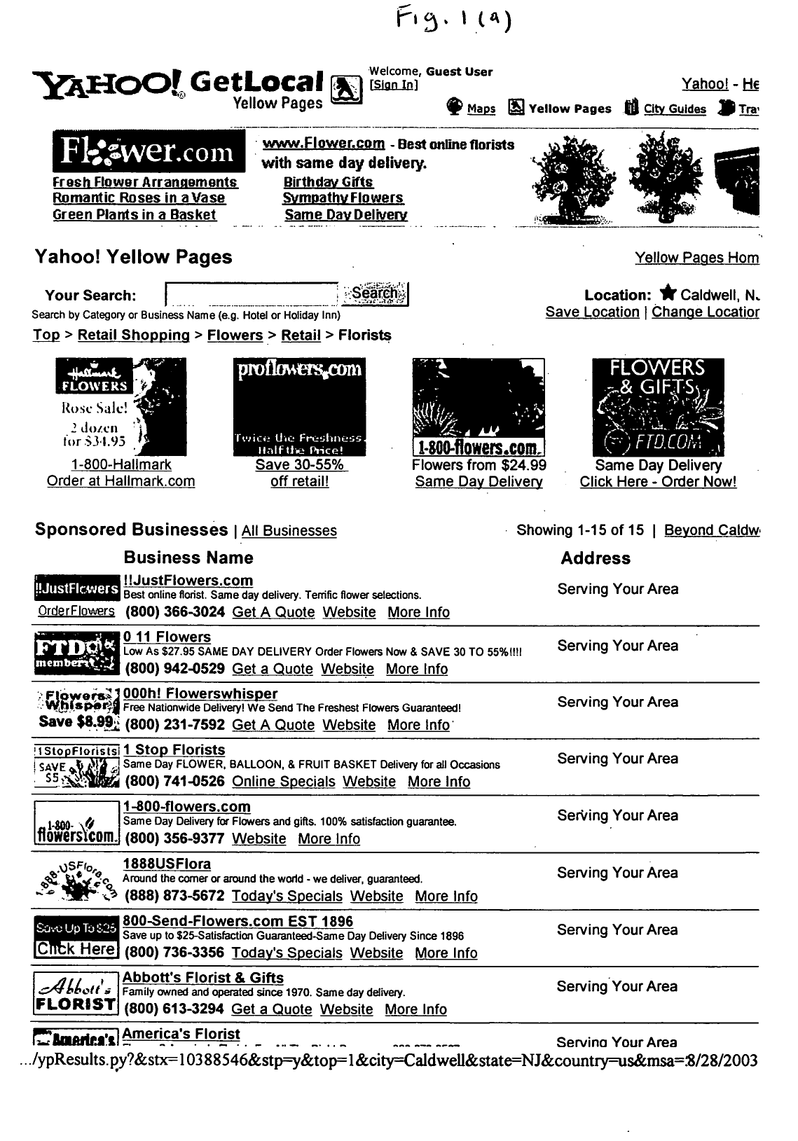

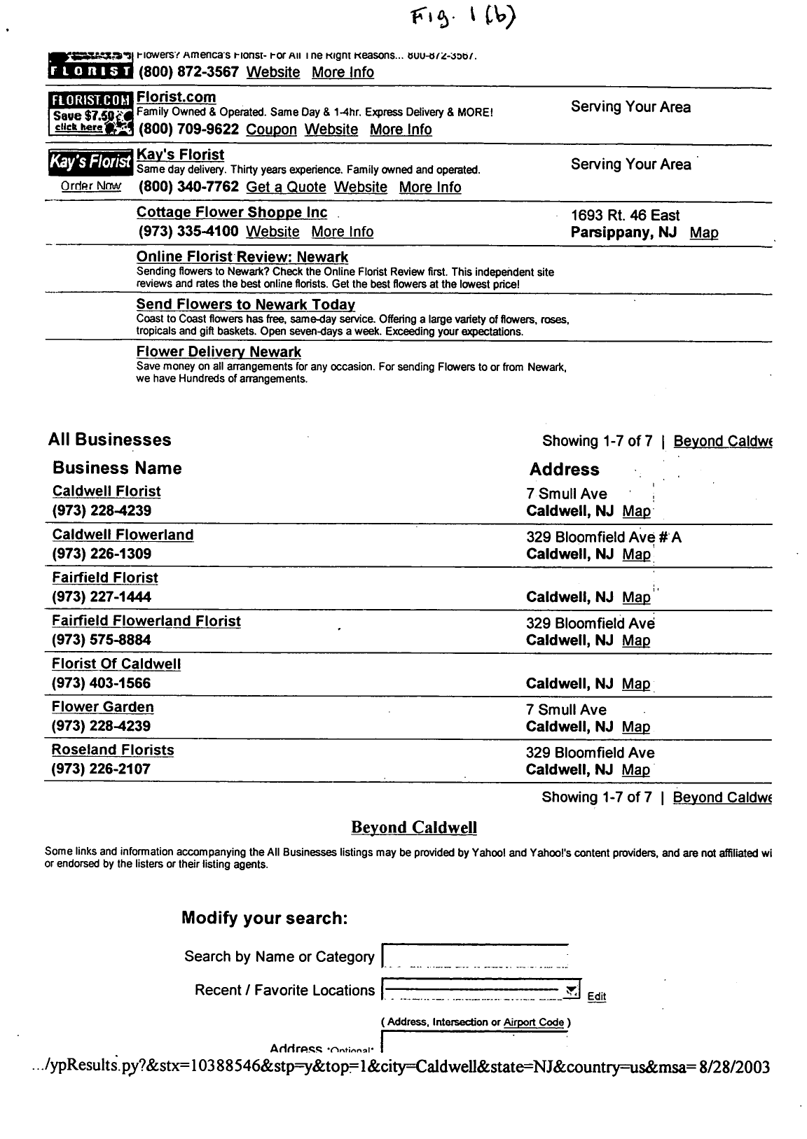

While the subject invention will now be described in detail with reference to the figures, it is done so in connection with the illustrative embodiments. Changes and modifications can be made to the described embodiments without departing from the true scope and spirit of the subject invention as defined by the appended claims.

### DETAILED DESCRIPTION OF THE PREFERRED EMBODIMENTS

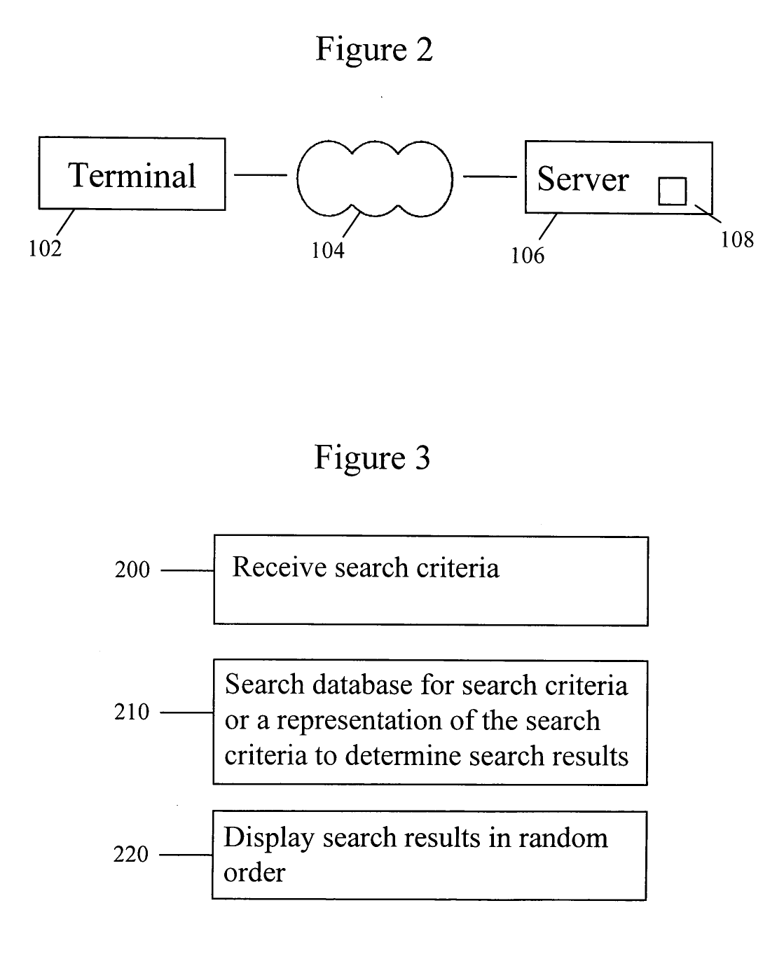

Referring to FIG. 2, there is depicted an exemplary system for displaying information according to the present invention. The illustrated system includes a terminal 102, which may be in the form of a personal computer. The terminal 102 may also take other forms, such as a personal data assistant or a cellular phone. The terminal 102 may communicate with a server 106 over a communications network 104. A database 108 may reside on the server 106. The database 108 may contain data pertinent to a business, such as the business name, address, and phone number.

Referring to FIG. 3, there is depicted an exemplary procedure for displaying search results. A processor may receive search criteria input or selected by a user at the terminal 102 for searching data pertinent to a business (step 200). The search criteria or a representation of the search criteria (such as a unique ID associated with each listing) may be passed to the server over the communications network 104 to start the search of a database for the search criteria or a representation of the search criteria, and the program on the server determines search results (step 210). The server 106 may contain a set of instructions to organize the search results in a random order and transmit the search results in a random order to the terminal over the communications network 104 to be displayed at the terminal. (step 220).

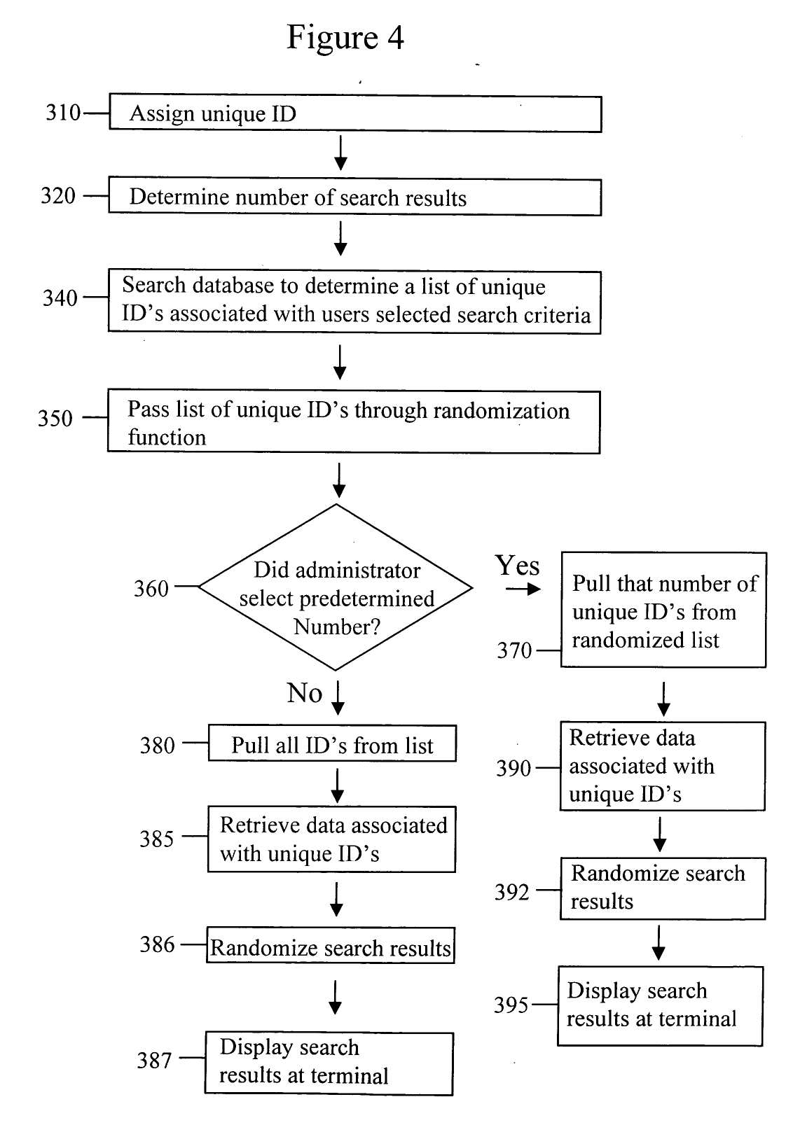

Referring to FIG. 4, there is depicted an exemplary procedure for determining the random order of search results. As a representation of each listing in the database, a unique ID may be assigned to each listing in the database (step 310). Optionally, an administrator may determine the number of search results to be displayed (step 320). A software program may perform the following steps. A database may be searched to determine a list of unique IDs associated with the user's selected or input search criteria (step 340). The list of unique ID's may be passed through a randomization function (step 350). A randomization function is well-known in the art. If an administrator selected a predetermined number of search results to be displayed (step 360), then that number of unique ID's may be pulled from the randomized list (step 370). Pertinent business information associated with each unique ID may be retrieved (step 390) and the predetermined number of search results may be randomized again (step 392) and may be displayed at a terminal (step 395). If no such determination of a number of search results to be displayed was made, then all the unique ID's may be pulled from the list (step 380). Pertinent business information associated with each unique ID may be retrieved (step 385) and all of the search results may be randomized again (step 386) and may be displayed at a terminal (step 387).

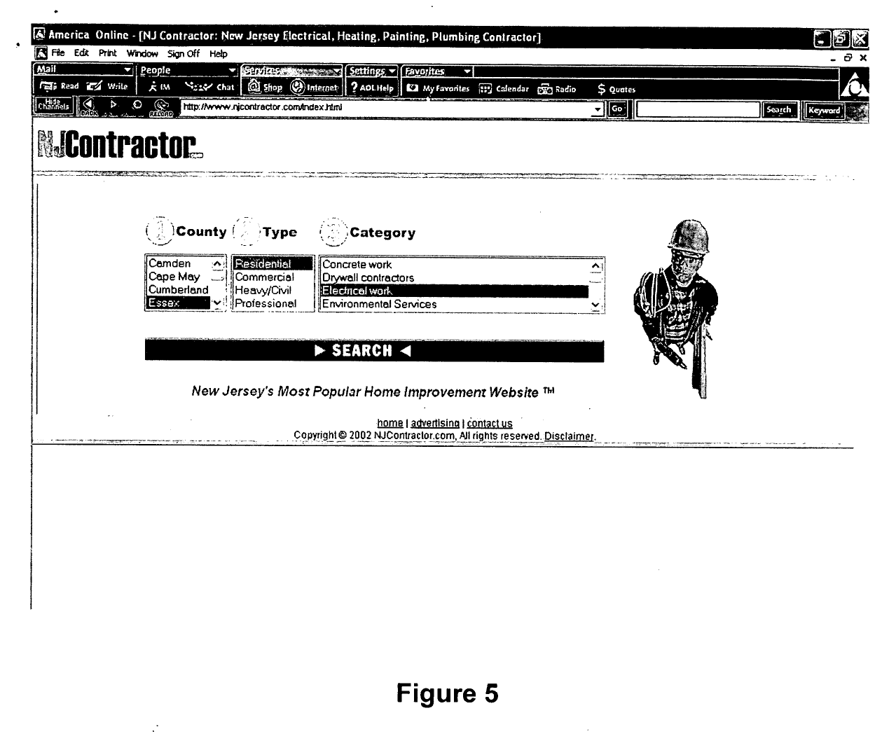

Referring to FIG. 5, there is depicted a screen shot of a webpage listing of contractors shown at the terminal 102 of a user according to an embodiment of the invention. The user may select search criteria such as county, type of contractor, and category of service provided (step 200). In this example, the user has selected “Essex” for county, “Residential” for type of contractor, and “Electrical work” for category of service. The search criteria is passed to the server over the communications network 104 to start the search of a database for unique ID's associated with the search criteria, and the program on the server determines search results (step 210).

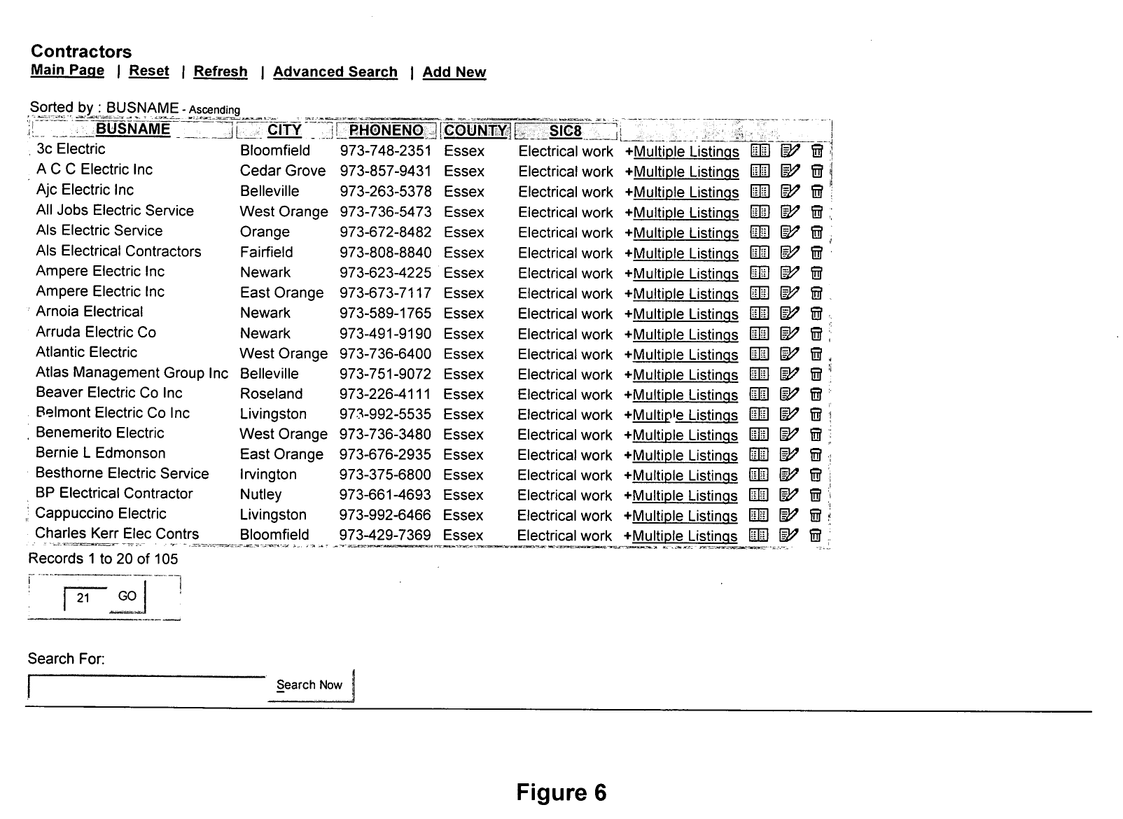

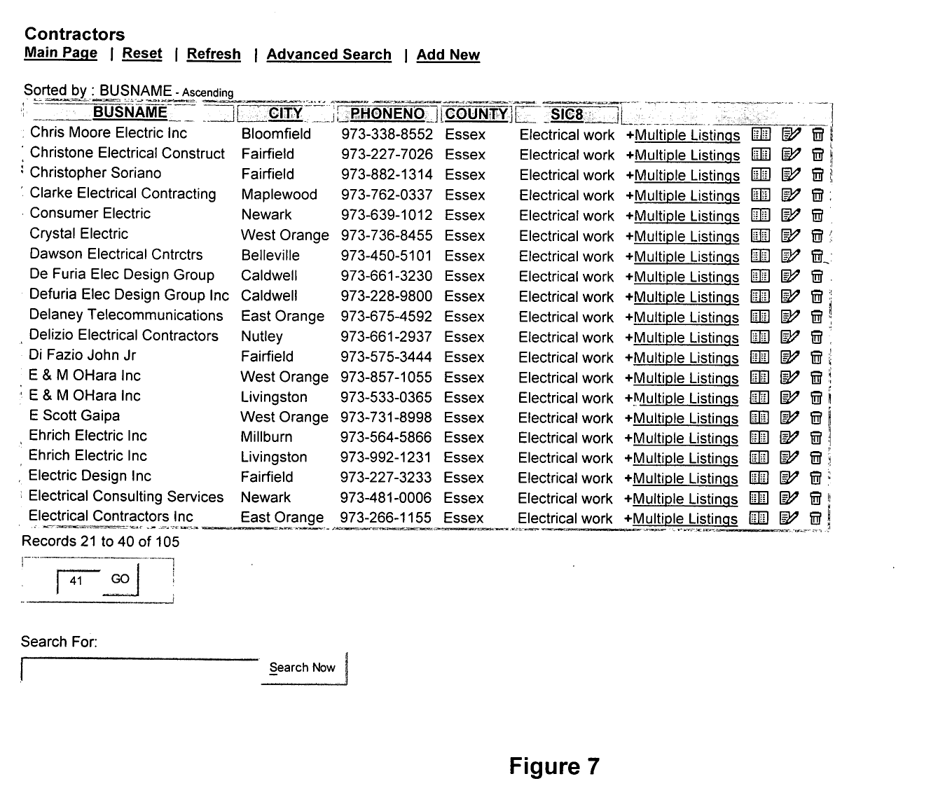

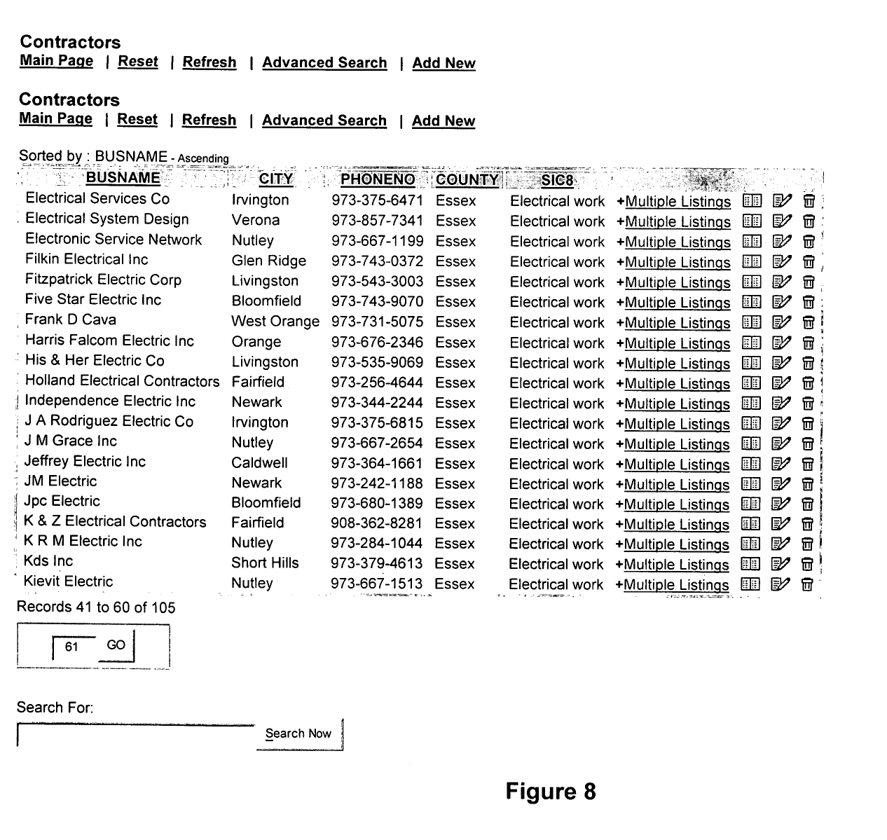

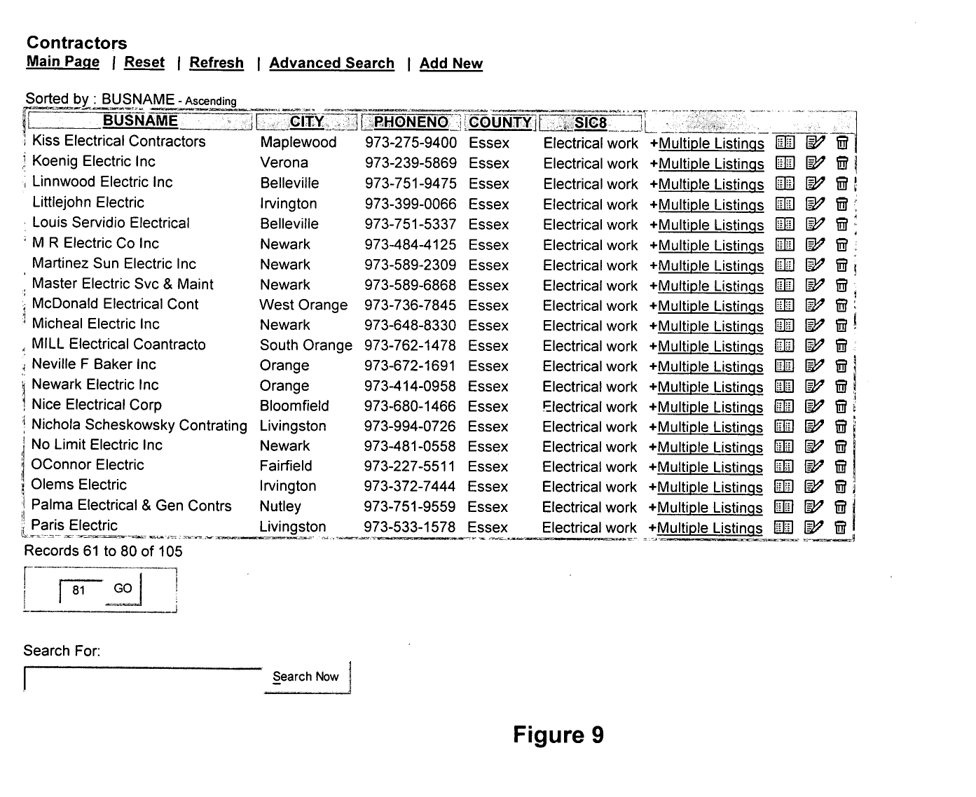

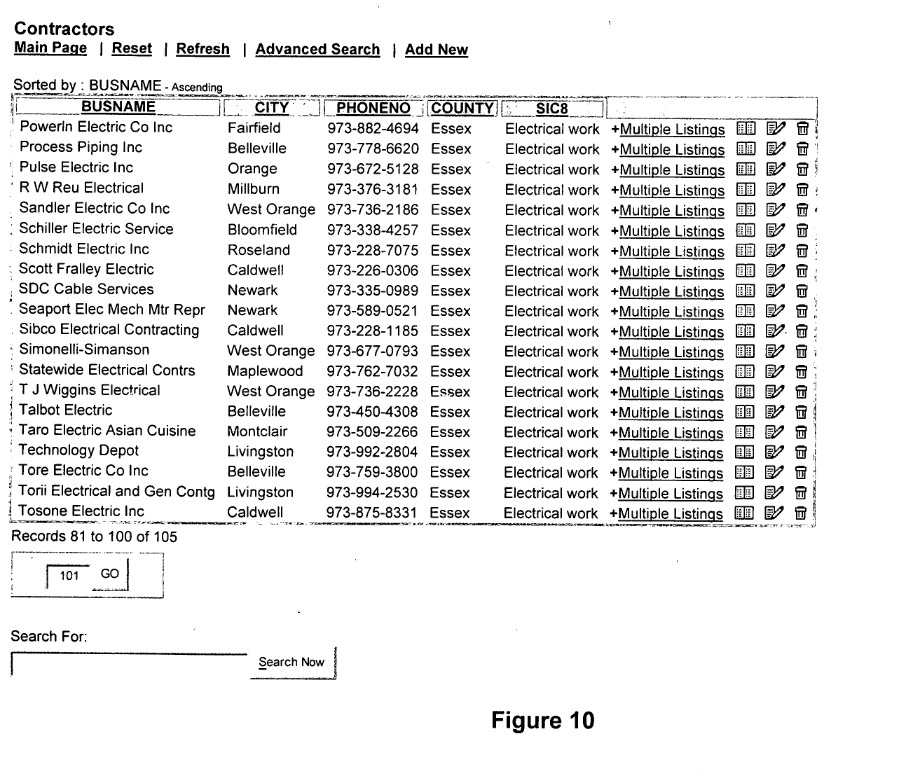

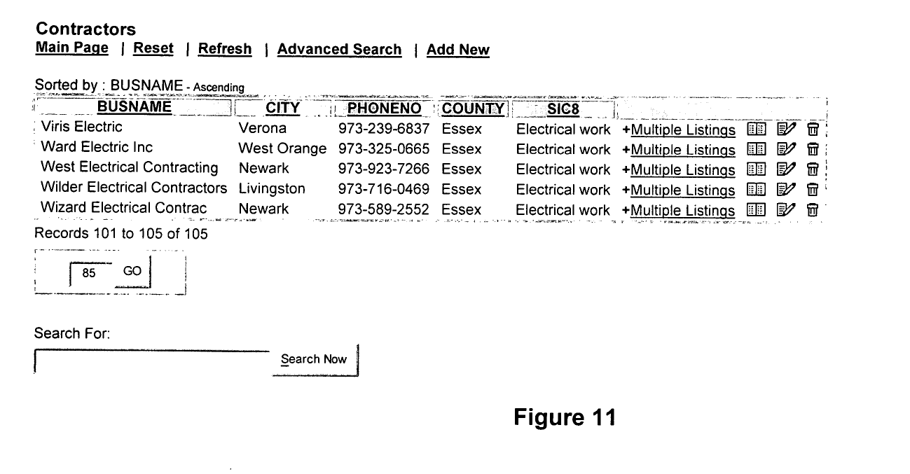

Referring to FIGS. 6-11, there is depicted an alphabetical listing of contractors stored in a database 108, which may be searched based on search criteria selected by the user.

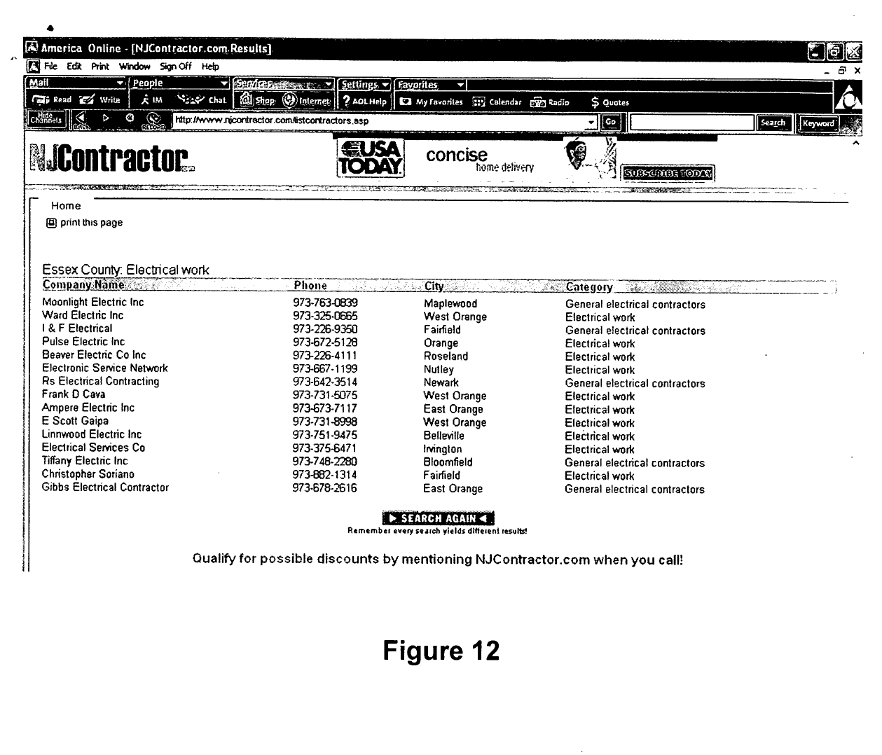

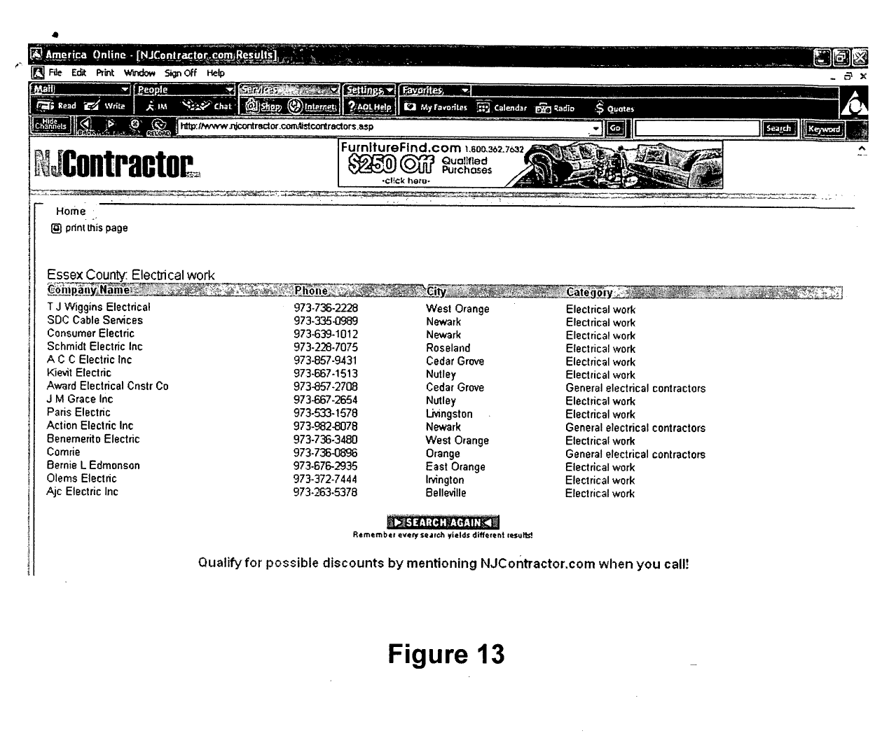

The search results then may be randomly organized and transmitted back over the communications network 104 to be displayed at the terminal 102 of the user (220). The search results are not in alphabetical order (except by chance), but rather are displayed in random order, as is depicted in FIG. 12. FIG. 13 depicts search results based on the same search criteria used in FIG. 12 (i.e., “Essex” for county, “Residential” for type of contractor, and “Electrical work” for category of service, in this example), but the search results are not the same as those of FIG. 12.

As is shown in FIGS. 12 and 13, an administrator may determine the amount of search results that are shown (in these cases, 15 results are shown). The number of search results displayed may be varied according to preference of the administrator, and no predetermined amount needs to be set. In addition to the typical search results, a first or “higher tier” search results list may also be provided, in which subscribers may pay a premium to have their name placed in the higher tier list. The first list appears before the second (basic) list. Although both lists may display the search results in a random order, the featured list may contain much of the same pertinent business information as the basic list but may display additional optional information about the search results on the first list. The exemplary procedure depicted in FIG. 4 may be used to determine the random order of search results for a higher tier list and/or a basic list.

Those skilled in the art will appreciate that the methods of FIGS. 2-13 can be implemented on various standard computer platforms operating under the control of suitable software defined by FIGS. 2-13. In certain cases, dedicated computer hardware, such as a peripheral card which resides on the bus of a standard personal computer, may enhance the operational efficiency of the above methods.

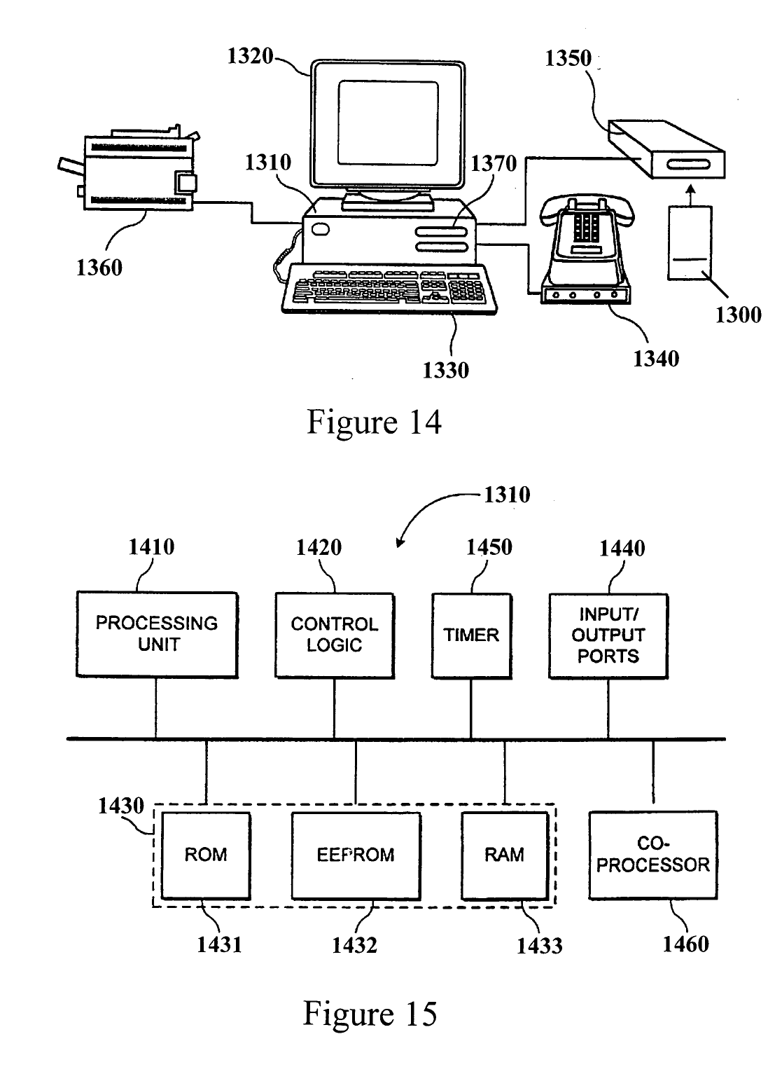

FIGS. 14 and 15 illustrate typical computer hardware suitable for practicing the present invention. Referring to FIG. 14, the computer system includes a processing section 1310, a display 1320, a keyboard 1330, and a communications peripheral device 1340 (e.g., a modem). The system may also include other input devices and a printer 1360. The computer system generally includes one or more disk drives 1370 which can read and/or write to computer readable media, such as magnetic media (i.e., diskettes) or optical media (i.e., CD-ROMS) for storing data and application software. While not shown for the sake of clarity, other input devices, such as a digital pointer (e.g., a “mouse”) and the like may also be included.

FIG. 15 is a functional block diagram which further illustrates the processing section 1310 of FIG. 14. The processing section 1310 generally includes a processing unit 1410, a control logic arrangement 1420 and a memory unit 1430. Preferably, the processing section 1310 can also include a timer 1450 and input/output ports 1440. The processing section 1310 can also include a co-processor 1460, depending on the microprocessor used in the processing unit. The control logic arrangement 1420 provides (in conjunction with processing unit 1410) the control necessary to handle communications between the memory unit 1430 and input/output ports 1440. A timer 1450 provides a timing reference signal for the processing unit 3010 and the control logic arrangement 1420. The co-processor 1460 provides an enhanced ability to perform complex computations in real time.

The memory unit 1430 may include different types of memory, such as volatile and non-volatile memory and read-only and programmable memory. For example, as shown in FIG. 15, the memory unit 1430 may include read-only memory (ROM) 1431, electrically erasable programmable read-only memory (EEPROM) 1432, and random-access memory (RAM) 1433. Different computer processors, memory configurations, data structures and the like can be used to practice the present invention, and the invention is not limited to a specific platform.

Although the present invention has been described in connection with specific exemplary embodiments, it should be understood that various changes, substitutions and alterations can be made to the disclosed embodiments without departing from the spirit and scope of the invention as set forth in the appended claims. For example, the database of information has been described as residing on a server, but the information may also be stored on a CD or other computer readable medium and loaded onto a user's PC (personal computer).

I claim:

1. A method of equalizing opportunity for exposure in search results comprising:
receiving search criteria;
searching a computer readable medium for the search criteria or a representation of the search criteria to determine the search results; and
displaying a first plurality of the search results in a random order.

2. The method of claim 1, wherein the first plurality of the search results are displayed in a random order in a first list.

3. The method of claim 2, further comprising displaying a second plurality of the search results in a random order in a second list.

4. The method of claim 1, wherein the number of the search results displayed is adjustable.

5. The method of claim 2, wherein the number of the search results displayed in the first list is adjustable.

6. The method of claim 3, wherein the number of the search results displayed in the second list is adjustable.

7. The method of claim 5, further comprising displaying a second plurality of the search results in a random order in a second list.

8. The method of claim 7, wherein the number of the search results displayed in the second list is adjustable.

9. The method of claim 1, wherein the representation of the search criteria is a unique identification number assigned to the search criteria

10. The method of claim 9, wherein the representation of the search criteria is a unique identification number assigned to the search criteria.

11. The method of claim 1, wherein the search criteria comprises a geographic location.

12. The method of claim 1, wherein the search criteria comprises a type of business.

13. The method of claim 1, wherein the search criteria comprises a yellow pages listing.

14. A system for equalizing opportunity for exposure in search results comprising a processing arrangement configured to perform the steps of:
receiving search criteria;
searching a computer readable medium for the search criteria or a representation of the search criteria to determine the search results; and
displaying a first plurality of the search results in a random order.

15. The system of claim 14, wherein the first plurality of the search results are displayed in a random order in a first list.

16. The system of claim 15, further comprising displaying a second plurality of the search results in a random order in a second list.

17. The system of claim 14, wherein the number of the search results displayed is adjustable.

18. The system of claim 15, wherein the number of the search results displayed in the first list is adjustable.

19. The system of claim 16, wherein the number of the search results displayed in the second list is adjustable.

20. The system of claim 18, further comprising displaying a second plurality of the search results in a random order in a second list.

21. The system of claim 20, wherein the number of the search results displayed in the second list is adjustable.

22. The system of claim 14, wherein the representation of the search criteria is a unique identification number assigned to the search criteria.

23. The system of claim 21, wherein the representation of the search criteria is a unique identification number assigned to the search criteria.

24. The system of claim 14, wherein the search criteria comprises a geographic location.

25. The system of claim 14, wherein the search criteria comprises a type of business.

26. The system of claim 14, wherein the search criteria comprises a yellow pages listing.

27. A computer readable medium for equalizing opportunity for exposure in search results, the computer-readable medium having a set of instructions operable to direct a processor to perform the steps of:
receiving search criteria;
searching a further computer readable medium for the search criteria or a representation of the search criteria to determine the search results; and
displaying a first plurality of the search results in a random order.

28. The computer readable medium of claim 27, wherein the first plurality of the search results are displayed in a random order in a first list.

29. The computer readable medium of claim 28, further comprising a set of instructions operable to direct the processor to perform the step of displaying a second plurality more of the search results in a random order in a second list.

30. The computer readable medium of claim 27, wherein the number of the search results displayed is adjustable.

31. The computer readable medium of claim 28, wherein the number of the search results displayed in the first list is adjustable.

32. The computer readable medium of claim 29, wherein the number of the search results displayed in the second list is adjustable.

33. The computer readable medium of claim 31, further comprising a set of instructions operable to direct the processor to perform the step of displaying a second plurality of the search results in a random order in a second list.

34. The computer readable medium of claim 33, wherein the number of the search results displayed in the second list is adjustable.

35. The computer readable medium of claim 27, wherein the representation of the search criteria is a unique identification number assigned to the search criteria.

36. The computer readable medium of claim 34, wherein the representation of the search criteria is a unique identification number assigned to the search criteria.

37. The computer readable medium of claim 27, wherein the search criteria comprises a geographic location.

38. The computer readable medium of claim 27, wherein the search criteria comprises a type of business.

39. The computer readable medium of claim 27, wherein the search criteria comprises a yellow pages listing.
